(19) United States
(12) Patent Application Publication
(10) Pub. No.: US 2026/0030414 A1
(43) Pub. Date: Jan. 29, 2026

(54) UNSUPERVISED MULTI-TARGET MOTION PROFILE SEQUENCE PREDICTION AND OPTIMIZATION

(71) Applicant: HITACHI VANTARA LLC, Santa Clara, CA (US)

(72) Inventors: Yongqiang ZHANG, Lexington, MA (US); Wei LIN, Plainsboro, NJ (US)

(21) Appl. No.: 19/099,145

(22) PCT Filed: Jul. 28, 2022
(86) PCT No.: PCT/US2022/038725

§ 371 Date: Jan. 28, 2025

(51) Int. Cl. G06F 30/27; G06F 111/02

(52) U.S. Cl. CPC G06F 30/27; G06F 2111/02

(57) ABSTRACT

Traditionally. motion profile sequences are designed manually, as there are numerous obstacles to automated design of motion profile sequences. Disclosed embodiments may utilize unsupervised learning and other techniques to automatically derive targets from sensor data, to train a predictive model that may concurrently predict target values for one or a plurality of targets for a motion profile sequence for each of one or a plurality of future time windows. The predictive model may be incorporated into an optimization process that identifies an optimal motion profile sequence, comprising one or more motion profiles. The optimal motion profile sequence may be deployed to a physical asset, to thereby control the physical asset to perform a task according to the motion profile sequence.

### BACKGROUND

### Field of the Invention

The embodiments described herein are generally directed to motion profiles in industrial systems, and, more particularly, to predicting target(s) based on a sequence of motion profiles and/or optimizing a sequence of motion profiles based on the predicted target(s).

### Description of the Related Art

Numerous industries operate position-controlled systems that drive repetitive tasks based on predefined motion profiles. A motion profile is a specification of one or more defined and controlled movements (e.g., a segment of a motion or sub-motion, a single motion, a series of motions, etc.) used by a physical asset to perform a task. Each motion profile may move a part of the physical asset or the physical asset itself to a specified position at a precise velocity or along a predetermined path. A motion profile may be defined by position, velocity, and/or acceleration. A plurality of motion profiles may be combined (e.g., in a particular order) into a motion profile sequence, which itself is a motion profile comprising multiple motions.

Examples of industries which utilize position-controlled systems include, without limitation, manufacturing facilities, amusement parks, airports, shipping ports, utilities, mining sites and facilities, oil and gas sites and facilities, warehouses, transportation facilities, and the like. Different industries and systems utilize different metrics, including key performance indicators (KPIs), to measure success. Such metrics represent the targets to be achieved by the physical assets. Examples of targets include, without limitation, production rate, yield rate, anomaly rate, failure rate, vibration level, energy consumption, noise (e.g., acoustic) level, position accuracy, user experience, and/or the like. In an industrial system in which motion profiles are developed and deployed, different motion profile sequences may cause a physical asset to behave differently, consume different resources, consume different amounts of resources, and/or produce different outcomes, in terms of one or more targets.

There are a number of problems with conventional means for target prediction and optimization for motion profile sequences. For example, traditionally, motion profiles are designed manually based on mathematical formulae, domain knowledge of the industrial system, and physical properties of the physical assets. The design process is subjective, time-consuming, and unreliable. In addition, these conventional means do not consider data collected during operation of the physical asset and feedback from operation of the physical asset.

As another example, conventional means focus on the design of motion profiles at the level of individual movements. They fail to consider optimization at the level of a sequence of motion profiles. For example, U.S. Patent Pub. No. 2016/0252894 describes a method that optimizes each sub-motion profile independently, and then combines those optimized sub-motion profiles into a motion profile.

As another example, conventional means generally utilize a single target during the design of a motion profile. However, the use of a single target cannot typically cover all performance aspects of an industrial system. A single target is also unable to incorporate correlations among multiple targets. A consideration of such correlations can lead to solutions with better performance.

As another example, conventional means generally rely on the collection of accurate target data to be used for supervised learning. However, for various reasons, accurate target data may not be available. Firstly, the targets may not be collected if there is no process for doing so or it is infeasible to collect the targets (e.g., due to a large volume of data). Secondly, even if some targets are collected, those targets may not be accurate or reliable if there is no standard process for effectively and efficiently collecting the targets or the targets are collected manually (e.g., by manually labeling sensor data based on domain knowledge). Thirdly, the collected target data may be incomplete. Incomplete data is sometimes the same as no data, since, for example, it can prevent insights such as the identification of a root cause of an anomaly.

As another example, conventional means generally design a motion profile based on a target value at a current time. This does not provide an operator or technician with an opportunity to respond or remediate when the target value is not optimal. In addition, optimization based on the target value at the current time may not be optimal over the long term.

The present disclosure is directed toward overcoming one or more of the problems discovered by the inventors.

### SUMMARY

Systems, methods, and non-transitory computer-readable media are disclosed to predict target(s) based on a motion profile sequence and available sensor data, and optionally use the predicted target(s) to optimize a motion profile sequence to achieve optimal values of the target(s).

In an embodiment, a method comprises using at least one hardware processor to train a predictive model to predict target values for a motion profile sequence, the method comprising: receiving a motion profile sequence comprising a sequence of motion profiles, wherein each motion profile defines one or more movements for a physical asset to perform a task; receiving sensor data associated with the motion profile sequence; generating training data from the motion profile sequence and the sensor data, wherein the training data comprise a plurality of feature sets, each of the plurality of feature sets comprising a feature value for each of one or more features derived from at least the motion profile sequence, and wherein each of the plurality of feature sets is labeled with a target value for each of a plurality of targets derived from at least the sensor data; and training a predictive model to predict a target value for each of the plurality of targets for at least one future time window, based on the training data. The method may further comprise determining an optimal motion profile sequence using the trained predictive model.

Determining an optimal motion profile sequence may comprise: generating a training dataset comprising a plurality of feature vectors, wherein each feature vector comprises a motion profile sequence, labeled with one or more target values for that motion profile sequence; until a stopping condition is satisfied, iteratively, building a surrogate model using the training dataset, maximizing an acquisition function of the surrogate model to identify a next motion profile sequence, applying the trained predictive model to one or more feature values derived for the next optimal motion profile sequence to predict at least one target value for the next motion profile sequence, and adding a feature vector to the training dataset, wherein the added feature vector comprises the next motion profile sequence, labeled with the at least one target value predicted for the next motion profile sequence; and, after the stopping condition is satisfied, select the optimal motion profile sequence based on the predicted at least one target values. The surrogate model may be a Gaussian regression model.

Each of the plurality of feature sets may be derived from both the motion profile sequence and the sensor data, and determining an optimal motion profile sequence may comprise: acquiring an existing motion profile sequence within a lookback window; selecting a plurality of potential motion profile sequences that include the existing motion profile sequence as a prefix; for each of the plurality of potential motion profile sequences, applying the trained predictive model to one or more feature values derived from the potential motion profile sequence and real-time sensor data to predict at least one target value for that potential motion profile sequence; and selecting the optimal motion profile sequence from the potential motion profile sequences based on the predicted at least one target values for the potential motion profile sequences. Selecting a plurality of potential motion profile sequences may comprise, from a set of available motion profile sequences that include the existing motion profile sequence as a prefix: splitting the set of available motion profile sequences into a first subset and a second subset, wherein each of the available motion profile sequences is associated with at least one previously determined target value, and wherein the first subset consists of motion profile sequences that are associated with higher values of the at least one previously determined target value than the second subset; randomly sampling a first number of potential motion profile sequences from the first subset; and randomly sampling a second number of potential motion profile sequences from the second subset. The method may further comprise controlling the physical asset to perform the task according to the optimal motion profile sequence.

Each of the one or more movements may be defined by one or more of a position, a velocity, or an acceleration. The sensor data may comprise one or both of historical data collected by sensors monitoring the physical asset or synthetic data generated using a simulation of the physical asset.

Generating training data may comprise: deriving an anomaly feature set based on the sensor data; and applying an anomaly scoring model to the anomaly feature set to produce an anomaly score, wherein the one or more features comprise the anomaly score. The method may further comprise using the at least one hardware processor to train the anomaly scoring model using unsupervised learning. Generating training data may further comprise applying an explainable artificial intelligence model to a surrogate anomaly scoring model, which has been trained using supervised learning, to determine a root cause for the anomaly score, wherein the one or more features further comprise the root cause. The anomaly feature set may comprise a feature value for each of a plurality of anomaly features, and the method may further comprise training the surrogate anomaly scoring model using a training dataset comprising a second plurality of feature sets, and wherein each of the second plurality of feature sets comprises a feature value for each of the plurality of anomaly features and is labeled with the anomaly score produced by the anomaly scoring model for that feature set. Generating training data may further comprise applying one or more feature selection techniques to a surrogate anomaly scoring model, which has been trained using supervised learning, to determine a selected feature set, wherein the one or more features further comprise the selected feature set. The anomaly feature set may comprise a feature value for each of a plurality of anomaly features, and the method may further comprise identifying the plurality of anomaly features by: generating a plurality of features from the sensor data; applying an autoencoder to the plurality of features to derive encoded features and decoded features; and calculating a difference between the plurality of features and the decoded features, wherein the plurality of anomaly features comprises one or more of the calculated difference, at least a subset of the plurality of features, or at least a subset of the encoded features.

The one or more features may comprise one or more of a position accuracy, vibration data, or acoustic data. The plurality of targets may comprise one or more of an anomaly score, a position accuracy, vibration data, or acoustic data. The method may comprise, during an operation stage: collecting feature values for the one or more features within a look-back window of sensor data generated for the physical asset; applying the predictive model to the collected feature values to predict the target value for each of the plurality of targets for the at least one future time window; and aggregating the predicted target values for the plurality of targets for the at least one future time window into an aggregated target value. The at least one future time window may be a plurality of future time windows, each of the plurality of future time windows comprising a different time period. The one or more features may be derived from only the motion profile sequence.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processes described herein, may be executed, according to an embodiment;

FIG. 3 illustrates an overall architecture for prediction and optimization, according to an embodiment;

FIG. 4 illustrates an example process for building feature and/or target data from sensor data, according to an embodiment;

FIG. 5 illustrates an example of anomaly detection, according to an embodiment;

FIG. 6 illustrates an overall architecture for using a trained predictive model to predict one or more targets of a motion profile sequence, according to an embodiment;

FIG. 7 illustrates a process for offline optimization, according to an embodiment; and

FIG. 8 illustrates a process for online optimization, according to an embodiment.

### DETAILED DESCRIPTION

In an embodiment, systems, methods, and non-transitory computer-readable media are disclosed for predicting target(s) for a motion profile sequence and/or optimizing a motion profile sequence based on the target(s). Both the prediction and optimization may be implemented in offline and/or online modes. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. System Overview

### 1.1. Infrastructure

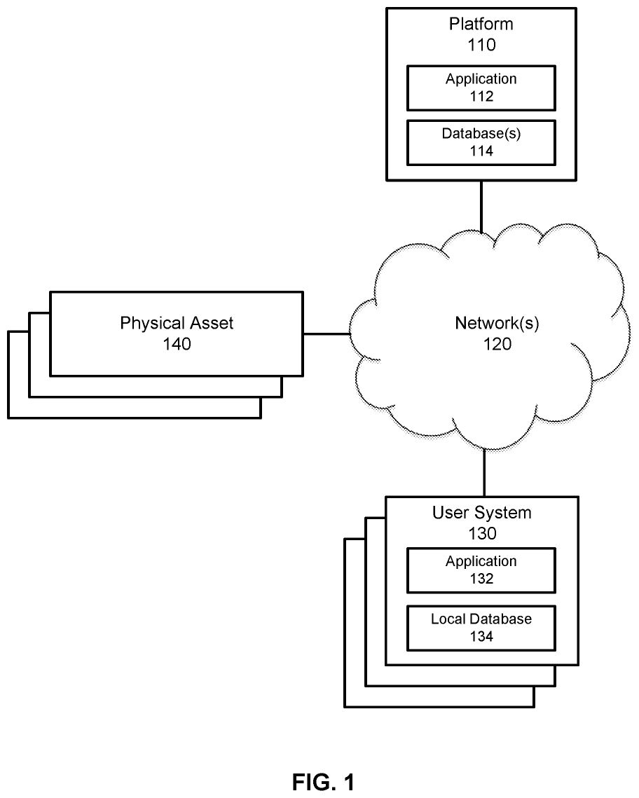

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more physical assets 140 via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or physical assets 140 via the Internet, but may be connected to one or more other user systems 130 and/or physical assets 140 via an intranet. Furthermore, while only a few user systems 130 and physical assets 140, one server application 112, and one set of database(s) 114 are illustrated, it should be understood that the infrastructure may comprise any number of user systems, physical assets, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 will comprise a personal computer or workstation of an agent of an entity responsible for operating or otherwise managing physical asset(s) 140. Each user system 130 may comprise or be communicatively connected to a client application 132 and/or one or more local databases 134.

Physical asset(s) 140 may comprise any type or types of machine with one or more moving components and/or which may itself move as a whole, and whose motion can be controlled by a motion profile (e.g., within a motion profile sequence). Examples of physical asset(s) 140 include, without limitation, a semi-autonomous or autonomous vehicle (e.g., automobile, motorcycle, airplane, helicopter, construction or mining vehicle, train, etc.), a drone, a robot (e.g., a robotic component of a manufacturing process, laboratory process, transportation process, etc.), an engine (e.g., turbine engine), a gas compressor, an amusement park ride (e.g., rollercoaster, tilt-a-whirl, ferris wheel, etc.), and the like. A controller or monitoring system of physical asset 140 may communicate with server application 112 on platform 110 to transmit a motion profile, by which physical asset 140 is being controlled, to platform 110, transmit sensor data (e.g., in real time or periodically) to platform 110, receive a motion profile by which physical asset 140 is to be controlled from server application 112, and/or the like. Thus, a user system 130 may utilize platform 110 to build, configure, and/or execute the prediction and/or optimization models described herein, configure and/or deploy the motion profile by which each physical asset 140 is controlled, and/or otherwise manage physical asset(s) 140.

A motion profile sequence may comprise a sequence of one or more motion profiles. Thus, a motion profile sequence can itself be thought of as a composite motion profile. Each motion profile in the motion profile sequence may define one or more movements for a physical asset 140 to perform a task. For example, a motion profile may provide the physical motion information for a series of movements and physically depict how a motor should behave during the series of movements. A controller (e.g., servo controller) of a physical asset 140 may use the motion profile to determine what commands (e.g., voltages) to send to the motor. In this case, the two most common types of motion profiles are triangular and trapezoidal, which are so-named because of their shapes when plotted as a function of time.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may comprise, be communicatively coupled with, or otherwise have access to one or more database(s) 114. For example, platform 110 may comprise one or more database servers which manage one or more databases 114. Server application 112 executing on platform 110 and/or client application 132 executing on user system 130 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, MongoDB™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from physical asset(s) 140, and provide responses in extensible Markup Language (XML), JavaScript Object Notation (JSON), and/or any other suitable or desired format. In such embodiments, platform 110 may provide an application programming interface (API) which defines the manner in which user system(s) 130 and/or physical asset(s) 140 may interact with the web service. Thus, user system(s) 130 and/or physical asset(s) 140, can define their own interfaces, and rely on the web service to implement or otherwise provide the backend processes, methods, functionality, storage, and/or the like, described herein. For example, in such an embodiment, a client application 132, executing on one or more user system(s) 130, may interact with a server application 112 executing on platform 110 to execute one or more or a portion of one or more of the various functions, processes, methods, and/or software modules described herein. In an embodiment, client application 132 may utilize a local database 134 for storing data locally on user system 130.

Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the software described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules comprising instructions that implement one or more of the processes, methods, or functions described herein.

### 1.2. Example Processing Device

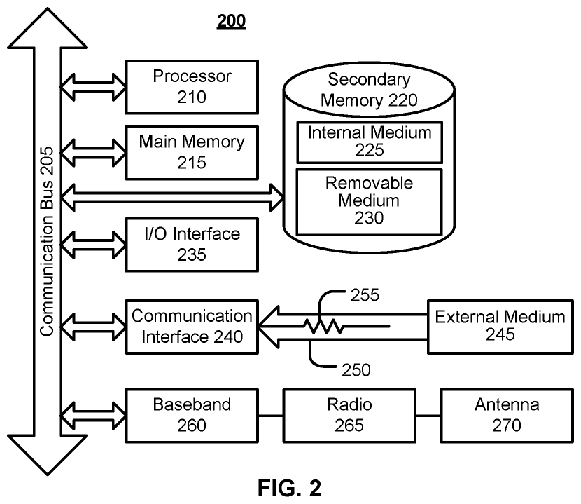

FIG. 2 is a block diagram illustrating an example wired or wireless system 200 that may be used in connection with various embodiments described herein. For example, system 200 may be used as or in conjunction with one or more of the functions, processes, or methods (e.g., to store and/or execute the software) described herein, and may represent components of platform 110, user system(s) 130, physical asset(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 210. Examples of processors which may be used with system 200 include, without limitation, any of the processors (e.g., Pentium™, Core i7™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 preferably includes a main memory 215 and may also include a secondary memory 220. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 is a non-transitory computer-readable medium having computer-executable code (e.g., any of the software disclosed herein) and/or other data stored thereon. The computer software or data stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may optionally include an internal medium 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, and/or the like.

In alternative embodiments, secondary memory 220 may include other similar means for allowing computer programs or other data or instructions to be loaded into system 200. Such means may include, for example, a communication interface 240, which allows software and data to be transferred from external storage medium 245 to system 200. Examples of external storage medium 245 include an external hard disk drive, an external optical drive, an external magneto-optical drive, and/or the like.

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server (e.g., platform 110) via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as the disclosed software) is stored in main memory 215 and/or secondary memory 220. Computer-executable code can also be received via communication interface 240 and stored in main memory 215 and/or secondary memory 220. Such computer programs, when executed, enable system 200 to perform the various functions of the disclosed embodiments as described elsewhere herein.

In this description, the term “computer-readable medium” is used to refer to any non-transitory computer-readable storage media used to provide computer-executable code and/or other data to or within system 200. Examples of such media include main memory 215, secondary memory 220 (including internal memory 225 and/or removable medium 230), external storage medium 245, and any peripheral device communicatively coupled with communication interface 240 (including a network information server or other network device). These non-transitory computer-readable media are means for providing software and/or other data to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform one or more of the processes and functions described elsewhere herein.

In an embodiment, I/O interface 235 provides an interface between one or more components of system 200 and one or more input and/or output devices. Example input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 200 may also include optional wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor(s) 210. Processor(s) 210 may have access to data storage areas 215 and 220. Processor(s) 210 are preferably configured to execute instructions (i.e., computer programs, such as the disclosed software) that can be stored in main memory 215 or secondary memory 220. Computer programs can also be received from baseband processor 260 and stored in main memory 210 or in secondary memory 220, or executed upon receipt. Such computer programs, when executed, can enable system 200 to perform the various functions of the disclosed embodiments.

### 2. Architecture Overview

Embodiments of architectures for predicting target(s) of a motion profile sequence and/or optimizing a motion profile sequence based on the target(s) will now be described in detail. It should be understood that the described processes, within these architectures, may be embodied in one or more software modules that are executed by one or more hardware processors (e.g., processor 210), for example, as a software application (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the software application are executed by platform 110 and other portions or modules of the software application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processor(s) 210. In addition, the disclosed software may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

### 2.1. Overall Prediction and Optimization

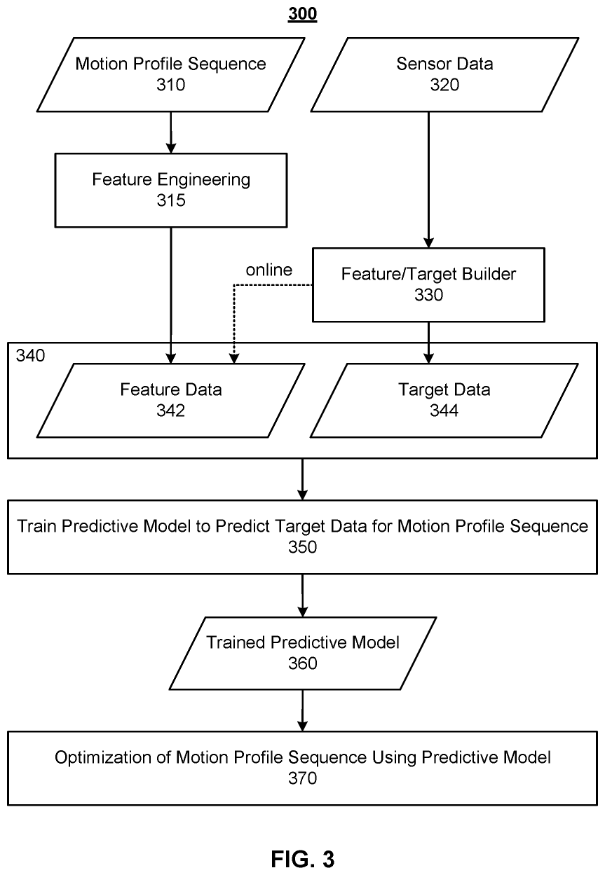

FIG. 3 illustrates an overall architecture 300 for prediction and optimization, according to an embodiment. Architecture 300 may accept one or more motion profile sequences 310 and sensor data 320 as inputs. Architecture 300 may comprise a process 315 for building feature data 342 of training data 340 from motion profile sequence 310, a process 330 for building feature data 342 and/or target data 344 of training data 340 from sensor data 320, a process 350 for training a predictive model 360 to predict the value of one or more targets using training data 340, and a process 370 for optimizing a motion profile sequence using trained predictive model 360.

Each motion profile sequence 310 may comprise a time series of motion profiles. It should be understood that certain motion profiles may be generic across a plurality of motion profile sequences, in which case, a motion profile sequence 310 may share one or more motion profiles with other motion profile sequences 310. In this case, efficiency may be achieved by defining each motion profile sequence 310 as a sequence of motion profile identifiers that each identify a defined motion profile. Thus, two different motion profile sequences 310 may reference the same motion profile identifier to incorporate the same motion profile.

Feature engineering 315 may derive one or more features from each motion profile sequence 310 in the format of a time series. For each time point in the time series, the motion profile at that time point (e.g., motion profile identifier) and/or one or more characteristics of the motion profile at that time point may be used as a data point in feature data 342. In addition, for each time point in the time series, one or more statistics about motion profile sequence 310 can be derived from a look-back window (e.g., comprising one or more time points within a time period preceding the time point), and used in the data points in feature data 342. These statistics may comprise, for example, the motion profile with the most occurrences within the look-back window, the length of non-operation time within the look-back window, the average non-operation time between consecutive motion profiles within the look-back window, and/or the like. The length of the look-back window can be determined based on domain knowledge and/or optimized using optimization techniques, such as grid search, random search, Bayesian optimization, and/or the like. All of the feature values derived by feature engineering 315 may be incorporated as data points into feature data 342 of training data 340.

Sensor data 320 may comprise a time series of outputs from one or more sensors. The time series of sensor data 320 may be correlated, in time, to the time series of motion profiles in a corresponding motion profile sequence 310 for which sensor data 320 was acquired. Thus, each sensor output can be associated with a particular motion profile in a particular motion profile sequence 320, and vice versa. The sensor outputs may be derived from physical sensors and/or virtual sensors. Examples of the types of sensors whose outputs are collected in sensor data 320 include, without limitation, temperature sensors, pressure sensors, vibration sensors, acoustic sensors, motion sensors, optical sensors, light detection and ranging (LIDAR) sensors, infrared (IR) sensors, acceleration sensors, gas sensors, smoke sensors, humidity sensors, level sensors, image sensors, proximity sensors, water quality sensors, chemical sensors, and like. The exact combination of sensors will depend on the type of physical asset 140, the task which physical asset 140 performs, the industry in which physical asset 140 is being used, and/or the like. Whether the sensors are physical or virtual is of no consequence to embodiments disclosed herein, and outputs from physical and virtual sensors may be processed in the same manner without having to distinguish between the two. Thus, embodiments may utilize only physical sensors, only virtual sensors, or any combination of physical and virtual sensors for each physical asset 140.

In the case of a physical sensor, the physical sensor may be installed on or otherwise monitor the physical asset 140 on which motion profile sequence 310 is deployed. For example, sensor data 320 may be collected by Internet of Things (IOT) and/or operational technology (OT) sensors that are physically installed on physical asset 140 to monitor the health and performance of physical asset 140 and/or the overall industrial system.

In the case of a virtual sensor, the sensor output may be calculated from a physics-based model or digital twin of physical asset 140 (e.g., using the output of one or more physical sensors as an input). Virtual sensors may be used in place of, or to supplement, physical sensors which may not be capable of capturing all metrics necessary for monitoring the health of physical asset 140. For example, certain physical sensors may not be feasible due to physical limitations of the hardware and/or the environment (e.g., high temperature, pressure, and/or radiation), or may not be capable of capturing data at a desired or necessary frequency. A physics-based model is a software-defined representation of the governing laws of nature that innately embeds the concepts of time, space, causality, and generalizability. These laws of nature define how physical, chemical, biological, and/or geological processes evolve. The physics-based model may be represented as a function that accepts one or more inputs and generates one or more outputs as the virtual sensor measurements. The input(s) may be derived from physical sensor(s).

In embodiments which utilize a combination of physical and virtual sensors to capture the same metric, the outputs of the physical sensors for the metric represent observed values, whereas the outputs of the virtual sensors for that metric represent expected values. In these cases, the variance of the difference between the observed and expected values can be calculated and used as a feature to detect anomalies in the operation of physical asset 140. In other words, the variance can be incorporated as a feature value in the data points of feature data 342.

By using virtual sensors with physical sensors, domain knowledge, represented by the underlying physics-based model, can be incorporated with the data-driven approach of physical sensors into downstream model(s). Physics-based models are theoretically self-consistent and have demonstrated successes in providing experimental predictions, which work well during design time. However, during operation, the complex system interactions and situations may cause a theoretical physics-based model to fall short of capturing the underlying mechanisms and become less accurate and sensitive. On the other hand, the data-driven approach of physical sensors can capture the subtle signals and patterns in the complex system and drive proper insights for decision-making. Thus, the combination of virtual and physical sensors enables a more robust model, without the higher costs associated with a purely data-driven approach.

Process 330 for building feature and/or target data may utilize one or a combination of techniques to derive the values of one or more feature(s) and/or one or more target(s), as a portion of feature data 342 and/or target data 344 within training data 340. It should be understood that these feature(s) and target(s) are derived for the time points within the same look-back window that is used by feature engineering 315, since the feature(s) and target(s) are correlated to the time series of motion profile sequence(s) 310. Examples of targets for which values may be derived in process 330 include, without limitation, anomaly data (e.g., anomaly scores, root causes for anomaly scores, etc.), position accuracy data, vibration data, acoustic data, efficiency, throughput, and/or the like. At least some of these targets may be derived automatically using unsupervised learning. Examples of features for which values may be derived in process 330 include, without limitation, anomaly data, position accuracy data, vibration data, acoustic data temperature, pressure, motion-sensor outputs, optical-sensor outputs, LIDAR outputs, IR outputs, acceleration, gas, smoke, humidity, level, image characteristics, proximity-sensor output, water quality, detected chemicals, and/or the like, including the output of any physical or virtual sensor described herein or applicable to physical asset 140. It should be understood that a feature in one implementation or application may be a target in another implementation or application, and that a target in one implementation or application may be a feature in another implementation or application. In other words, whether a particular sensor output or data derived from a particular sensor output are treated as a feature or a target in training data 340 may depend on the particular implementation and/or application. Thus, it should be understood that any data described herein as a feature may be used as a target in an alternative embodiment, and any data described herein as a target may instead be used as a feature in an alternative embodiment.

Process 350 uses training data 340 to train a predictive model 360 to predict the value of each target represented in target data 344, in one or more future time windows, based on the features represented in feature data 342 for a given motion profile sequence. In particular, training data 340 may comprise labeled feature vectors, wherein each feature vector comprises a value of each feature represented in feature data 342 and is labeled with a value for each target represented in target data 344. The target values with which the feature vectors are labeled represent the ground truth for training.

Predictive model 360 may be trained and operated in either an offline mode or an online mode. The primary difference between the offline and online modes is that, in the online mode, one or more features (e.g., for which values are included in feature data 342) to be used during training and operation are derived from sensor data 320. In other words, in the online mode, both feature values, incorporated into feature data 342, and target values, incorporated into target data 344, are derived from sensor data 320. In contrast, in the offline mode, only target values, incorporated into target data 344, are derived from sensor data 320. Consequently, in the offline mode, feature data 342 consists of feature values that are derived solely from motion profile sequence 310. The reason for this difference is that, in the offline mode, it is assumed that sensor data 320 will not be available during the operation of predictive model 360. Accordingly, in the offline mode, predictive model 360 should not be trained using features that are derived from sensor data 320.

In an embodiment, both offline and online versions of predictive model 360 may be trained. In this case, trained predictive model 360 may be operated in either the offline mode or the online mode, depending on user selection, one or more user or system settings, whether or not sensor data is available during operation, and/or the like. In an alternative embodiment, only an offline version of predictive model 360 may be trained and operated, or only an online version of predictive model 360 may be trained and operated.

It should be understood that the features represented in feature data 342 of training data 340 will be the same features that will be represented in the input data on which trained predictive model 360 will operate. Thus, the same processes by which feature data 342 is generated from motion profile sequence 310 (and, in the online mode, from sensor data 320 by process 330) during training may be used to derive the input data from the motion profile sequence (and, in the online mode, from real-time sensor data) during operation. In addition, it should be understood that the targets represented in target data 344 of training data 340 will be the same targets that will be represented in the output of trained predictive model 360.

Trained predictive model 360 may be used by one or more downstream functions. In an embodiment, these downstream function(s) comprise an optimization process 370. Optimization process 370 may differ based on whether predictive model 360 was trained in an offline mode or an online mode. In either case, optimization process 370 utilizes trained predictive model 360 to optimize a motion profile sequence, as discussed elsewhere herein.

### 2.2. Feature and Target Builder

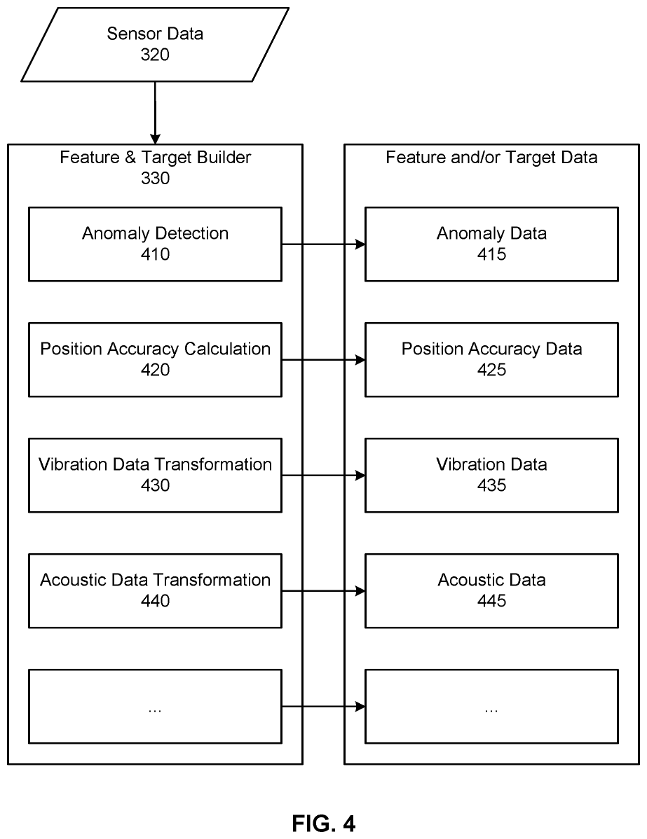

FIG. 4 illustrates an example of process 330 for building feature and/or target data from sensor data 320, according to an embodiment. As illustrated, process 330 may comprise anomaly detection 410, position accuracy calculation 420, vibration data transformation 430, and acoustic data transformation 440. It should be understood that this is simply an example, and that process 330 may comprise more, fewer, or a different combination of detection, calculation, and/or transformation subprocesses. Similarly, the resulting feature and/or target data may comprise more, fewer, or a different combination of data.

As discussed elsewhere herein, in the online mode, process 330 will only output target data 344, whereas, in the offline mode, process 330 will output both target data 344 and at least a portion of feature data 342. In addition, whether data is a feature or a target will depend on the particular implementation. Thus, while it is generally contemplated that anomaly data 415, position accuracy data 425, vibration data 435, and/or acoustic data 445 will be used as targets represented in target data 344, any combination of these data may be used instead as features in feature data 342.

Anomaly detection 410 may process sensor data 320 to produce an indication of the likelihood of any failures or other anomalies in physical asset 140 or the overall industrial system. The output of anomaly detection 310 is anomaly data 415, which may comprise an anomaly score for each time point in the time series of sensor data 320. The anomaly score may indicate a likelihood that motion profile sequence 310 experienced an anomaly at the associated time point. For example, each anomaly score may be a value within a predefined range (e.g., 0 to 1), with larger values representing a higher likelihood of an anomaly. Alternatively or additionally, anomaly data 415 may comprise an aggregated anomaly score derived by aggregating the anomaly scores across the whole time series. In an embodiment, anomaly detection 410 is implemented using unsupervised learning.

Position accuracy calculation 420 may process sensor data 320 to calculate position accuracy data 425. In particular, sensor data 320 may comprise positions of physical asset 140 at each time point in the time series of sensor data 320, as well as expected positions (e.g., from control signals) of physical asset 140 at each time point in the time series of sensor data 320. A difference can be calculated between the observed position and the expected position at each time point in the time series of senor data 320. These differences can then be aggregated across the whole time series to produce an aggregated position accuracy, which may be included in position accuracy data 425, instead of or in addition to the differences calculated at each time point. The aggregation may comprise an average, weighted average, minimum, maximum, and/or the like.

Vibration data transformation 430 may process sensor data 320 to calculate vibration data 435. In particular, sensor data 320 may comprise vibration data of physical asset 140 in the frequency domain. Vibration data transformation 430 may transform this vibration data from the frequency domain into the spatial domain using a transformation technique, such as Fast Fourier Transformation (FFT). The vibration data (e.g., vibration level) may be transformed at each time point in the time series of sensor data 320. This transformed vibration data can then be aggregated across the whole time series to produce aggregated vibration data (e.g., vibration level), which may be included in vibration data 435, instead of or in addition to the vibration data at each time point. The aggregation may comprise an average, weighted average, minimum, maximum, and/or the like.

Acoustic data transformation 440 may process sensor data 320 to calculate acoustic data 445. In particular, sensor data 320 may comprise acoustic data (e.g., sound, noise, etc.) of physical asset 140 in the frequency domain. Acoustic data transformation 440 may transform this acoustic data from the frequency domain into the spatial domain using a transformation technique, such as Fast Fourier Transformation (FFT). The acoustic data (e.g., acoustic level) may be transformed at each time point in the time series of sensor data 320. This transformed acoustic data can then be aggregated across the whole time series to produce aggregated acoustic data (e.g., acoustic level), which may be included in acoustic data 445, instead of or in addition to the acoustic data at each time point. The aggregation may comprise an average, weighted average, minimum, maximum, and/or the like.

Sensor data 320 may also comprise explicitly collected data, which may be copied directly from sensor data 320 into the values of features and/or targets. For example, such data may comprise production or yield rate, user experience scores (e.g., collected from questionnaires), and/or the like.

It should be understood that the above are non-limiting examples of the metrics that may be extracted or otherwise derived from sensor data 320. More, fewer, or a different combination of one or more metrics may be collected. In any case, each of the collected metrics may be used as either a target (e.g., in both offline and online modes) or a feature (e.g., in the online mode), depending on the particular implementation and/or application. In some cases, a metric may be both a feature and a target. For example, the metric at a prior time may be used as a feature to predict the metric at a future time as a target.

### 2.3. Anomaly Detection

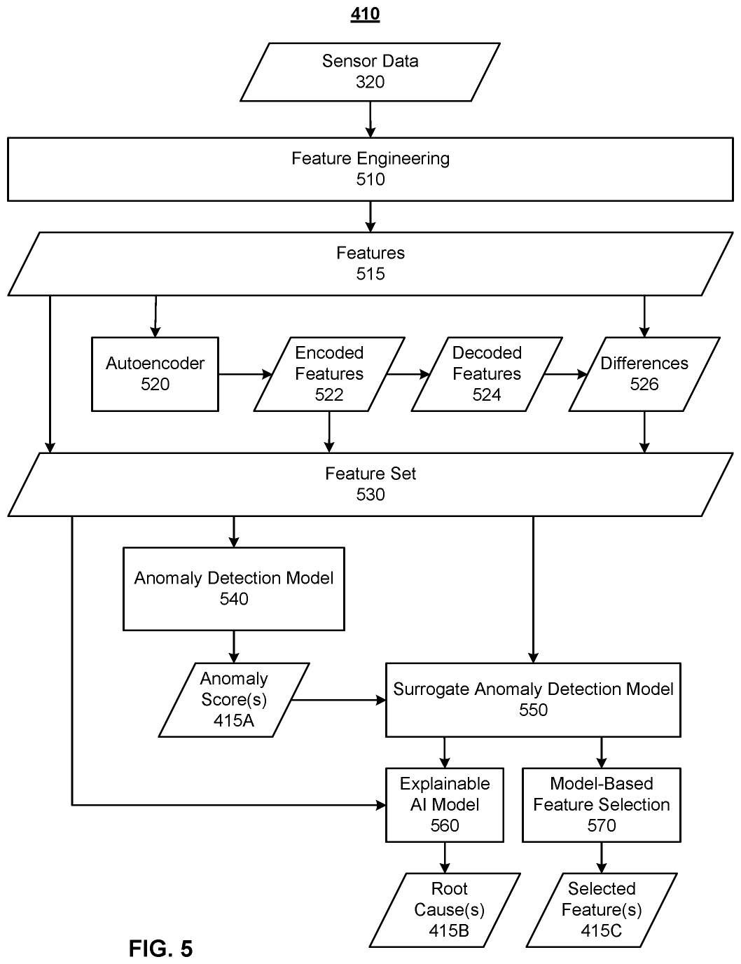

FIG. 5 illustrates an example of anomaly detection 410, according to an embodiment. Anomaly detection receives sensor data 320 as input, and outputs anomaly data 415, which may comprise anomaly scores 415A, root causes 415B, and selected features 415C. Anomaly data 415 may comprise feature and/or targets values for each individual time point in the time series of sensor data 320, and/or aggregated values of features and/or targets across multiple time points (e.g., the entire time series).

Feature engineering 510 may convert sensor data 320 into one or more features 515 in the format of a time series, with a value of the feature(s) for each time point in the time series. For example, one or more sensor outputs in sensor data 320 may be down-sampled from a higher frequency to a lower frequency, using aggregation techniques, such as mean, maximum, minimum, and/or the like, to combine a plurality of time points into a single down-sampled time point. As another example, one or more features may be derived from sensor data 320 for each time point in the time series using moving average, moving variance, differencing (e.g., first order derivation, second order derivation, etc.), 1 percentile, 99 percentile, and/or the like. As yet another example, for each time point in the time series, statistics can be derived from a look-back window (e.g., sensor outputs and/or derived features at one or more time points within a time period preceding the time point), and these statistics can be used as additional features for the time point. The length of this look-back window can be determined based on domain knowledge and/or optimized using optimization techniques, such as grid search, random search, Bayesian optimization, and/or the like. One or more, and potentially all of, features 515, output from feature engineering 515, may be added to feature set 530.

An autoencoder 520 may be used to identify additional signals in features 515. Autoencoder 520 is an unsupervised learning technique that utilizes a neural network architecture to impose a bottleneck in the network. In particular, both the input layer and the output layer of the neural network are the same. In other words, the set of features that are output from the neural network are the same features 515 that are input into the neural network. A bottleneck is imposed by a hidden layer between the input and output layers that consists of a fewer number of units than the input and output layers. This bottleneck forces features 515 to be compressed into a set of encoded features 522 within the hidden layer. Autoencoding works if some structure exists in the data (e.g., correlations between two or more features within features 515). The neural network learns and leverages this structure and removes redundant information to produce encoded features 522. It should be understood that the number of encoded features 522 will be less than the number of features 515 in the original input to the neural network. One or more, and potentially of, encoded features 522 may be added to feature set 530.

Encoded features 522 may be reconstructed into the set of features in the original input to produce decoded features 524 (e.g., the output of autoencoder 524). It should be understood that, since some information is lost in the compression of autoencoder 520, decoded features 524 will generally differ from features 515. Decoded features 524 can be regarded as the expected values, whereas features 515 can be regarded as the observed values. The differences 526 between features 515 and decoded features 524 may be calculated, and one or more, and potentially all of, differences 526 may be added, individually or as an aggregation, as features to feature set 530. Differences 526 may represent additional information that can be used to detect an anomaly.

Feature set 530 may comprise features 515, encoded features 522, and/or differences 526, or any subset or combination of features 515, encoded features 522, and differences 526. During training, feature engineering 510 and autoencoder 520 are applied to sensor data 520 to derive feature set 530 in order to train anomaly detection model 540 and surrogate anomaly detection model 550. During operation in an online mode, feature engineering 510 and autoencoder 520 are applied to sensor data 520 to derive feature set 530 as inputs to anomaly detection model 540 and surrogate anomaly detection model 550, in order to produce predicted values for anomaly scores 415A, root causes 415B, and selected features 415C. In both cases, feature engineering 510 and autoencoder 520 may operate in an identical manner.

Anomaly detection model 540 may be trained to generate an anomaly score for each data point in feature set 530 (e.g., each data point corresponding to a time point in the time series of sensor data 320 or an aggregation of time points in the time series of sensor data 320). Any anomaly detection algorithm may be used for anomaly detection model 540. However, in an embodiment, anomaly detection model 540 is trained using unsupervised learning, such that the target data in the training data does not need to be manually collected or defined. For example, anomaly detection model 540 may utilize Isolation Forest, Local Outlier Factor, Robust Covariance, One-Class Support Vector Machine, and/or similar algorithms. Alternatively, anomaly detection model 540 could utilize an algorithm that is trained using supervised learning.

In an embodiment, anomaly detection model 540 may comprise an ensemble of models (i.e., a plurality of models). Each model in the ensemble may utilize a different anomaly detection algorithm. The ensemble may consist of models that are only trained using unsupervised learning, consist of models that are only trained using supervised learning, or comprise both models that are trained using unsupervised learning and models that are trained using supervised learning. In any case, the anomaly score that is output by each model in the ensemble may be aggregated into a single anomaly score 415A for the ensemble for each data point. The aggregation may comprise an average, weighted average, minimum, maximum, and/or the like. The use of an ensemble as anomaly detection model 540 can eliminate or reduce the bias that may result from only using a single model. It should be understood that, during operation, the anomaly score 415A, output by anomaly detection model 540 for a given data point, indicates a likelihood that the data point represents an anomaly (e.g., with higher values representing a higher likelihood).

Surrogate anomaly detection model 550 may be trained to generate an anomaly score for each data point in feature set 530 using supervised learning. In particular, the training data for surrogate anomaly detection model 550 may comprise, for each data point, a feature vector comprising the feature values for that data point in feature set 530, labeled with the anomaly score 415A predicted by anomaly detection model 540 for that feature vector. Surrogate anomaly detection model 550 may comprise a Random Forest algorithm. Alternatively surrogate anomaly detection model 550 could utilize other machine-learning algorithms, such as a neural network, gradient descent, support vector machine, Bayesian method, or the like. In essence, surrogate anomaly detection model 550 is trained to predict or approximate the anomaly score 415A that would be output by anomaly detection model 540, given the same set of feature values. In other words, surrogate anomaly detection model 550 is a surrogate to anomaly detection model 540.

It should be understood that, in practice, the particular feature set 530 on which anomaly detection model 540 is trained may be, but does not have to be, the same as the particular feature set 530 on which surrogate anomaly detection model 550 is trained. For example, anomaly detection model 540 may be trained on a first feature set 530. Subsequently, the trained anomaly detection model 540 may be applied to a second feature set 530 to generate anomaly scores 415A, which may then be used to label the corresponding data points in the second feature set 530. This labeled second feature set 530 may then be used to train surrogate anomaly detection model 550.

During operation, explainable artificial intelligence (AI) model 560 may analyze the application of surrogate anomaly detection model 550 to a particular data point in an input feature set 530 to determine root cause(s) 415B. For example, an input feature set 530 may comprise a feature vector that consists of a feature value for each feature represented in feature set 530. Explainable AI model 560 may identify which of the features, represented in the feature vector, contribute the most to the output (i.e., the surrogate anomaly score) of surrogate anomaly detection model 550. In particular, the contribution of each feature may be measured by or based on a weight value, and features whose measured contributions exceed a threshold and/or a number of features with the highest measured contributions may be identified as root causes of the surrogate anomaly score, and output as root cause(s) 415B. Explainable AI model 560 may comprise the ELI5 package in Python™, the Shapely Additive Explanations (SHAP) package in Python™, the Lime package in Python™, and/or any other open source or non-open source packages, libraries, or other algorithms designed to explain the result of surrogate anomaly detection model 550.

Model-based feature selection 570 may analyze surrogate anomaly detection model 550 to identify important features using one or more feature-selection techniques. Examples of feature-selection techniques include, without limitation, forward selection, backward elimination, exhaustive, best first, genetic, particle swarm optimization, targeted projection pursuit, scatter search, variable neighborhood search, and/or other algorithms. The output of model-based feature selection 570 is a subset 415C of the most important features to surrogate anomaly detection model 550, from among the features represented in feature set 530. During training, selected features 415C may be used as features or targets to train predictive model 560, and during operation, these selected features 415C may be used as inputs to predictive model 560 (e.g., in an online mode).

In summary, anomaly detection 410 may output anomaly data 415 comprising, for each data point in sensor data 320, anomaly score(s) 415A, root cause(s) 415B for those anomaly scores 415A, and/or the value of selected feature(s) 415C. Anomaly data 415 represent the likelihood that a motion profile sequence 310 will produce an anomaly (e.g., failure). During training, each type of anomaly data 415 may be used as either a feature or target to train predictive model 360. During operation, each type of anomaly data 415 that was used as a feature to train predictive model 360 is used in the input to trained predictive model 360. In a particular implementation, root causes 415B and selected features 415C are used as features (e.g., in combination with one or more features derived from motion profile sequence 310 by feature engineering 315), and anomaly scores 415A, position accuracy data 425, vibration data 435, and acoustic data 445 are used as the targets.

### 2.4. Predictive Model

Predictive model 360 may comprise a deep-learning neural network, such as a Recurrent Neural Network (RNN). Examples of a Recurrent Neural Network include, without limitation, a Long Short-Term Memory (LSTM) network, a Gated Recurrent Unit (GRU) network, and the like. However, it should be understood that predictive model 360 may comprise other types of machine-learning models, including other types of neural networks.

In an embodiment, predictive model 360 is trained to predict the target value of each of one or more targets for each of one or more future time windows. For example, predictive model 360 may predict the target value of each of a plurality of targets for a single future time window, predict the target value of a single target for each of a plurality of future time windows, or predictive the target value of each of a plurality of targets for each of a plurality of future time windows. In an embodiment of predictive model 360 that predicts a plurality of targets and/or a target for each of a plurality of future time windows, the plurality of targets and/or the future time windows may be defined based on business requirements or other criteria.

In an embodiment of predictive model 360 that predicts a target value for each of a plurality of future time windows, training data 340 may comprise, for each data point, a feature set (e.g., feature vector) that comprises feature values for each feature represented in feature data 342, and a target value for each of the plurality of future time windows. In this case, during operation, predictive model 360 will predict the target value for each of the plurality of future time windows, given an input feature set comprising feature values for each feature represented in feature data 342.

In an embodiment of predictive model 360 that predicts a plurality of target values for a future time window, training data 340 may comprise, for each data point, a feature set that comprises feature values for each feature represented in feature data 342, and a target value for each target represented in target data 344. In this case, during operation, predictive model 360 will predict the target value for each target represented in target data 344, given an input feature set comprising feature values for each feature represented in feature data 342.

In an embodiment of predictive model 360 that predicts a plurality of target values for a plurality of future time windows, training data 340 may comprise, for each data point, a feature set that comprises feature values for each feature represented in feature data 342, and a target value for each target represented in target data 344 for each of the plurality of future time windows. In this case, during operation, predictive model 360 will predict the target value for each of the targets represented in target data 344 for each of the plurality of future time windows, given an input feature set comprising feature values for each feature represented in feature data 342.

The use of a single predictive model 360 to concurrently predict multiple targets and/or in multiple future time windows may achieve better performance with a shorter overall training time, relative to a predictive model that predicts a single target and/or in a single future time window. This is because multiple targets in a time window and/or across time windows may be correlated to each other, and may share similar parameters or weights in predictive model 360. For example, each target value that is predicted in one future time window may benefit other target values of the same target in other future time windows, when the predicted target value is adjusted to remove noise. Training one predictive model, versus training multiple predictive models (e.g., for each target and/or each future time window), not only improves run time performance, but also significantly reduces training time.

### 2.5. Operation of Predictive Model

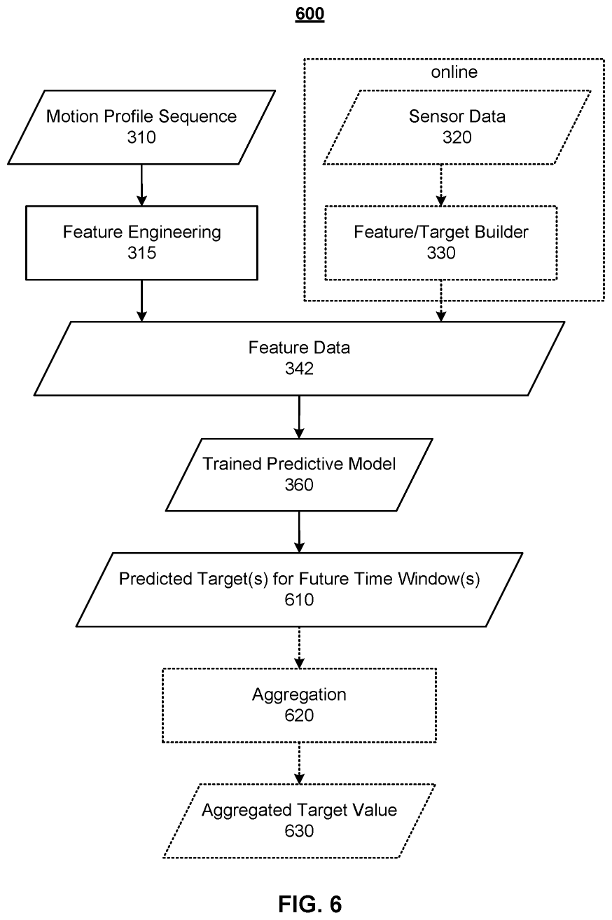

FIG. 6 illustrates an overall architecture 600 for using trained predictive model 360 to predict one or more targets of a motion profile sequence 310, according to an embodiment. During operation, a motion profile sequence 310 that is the subject of the prediction may be received as input. Generally, only a single motion profile sequence 310 will be provided per prediction. Feature data 342 may be derived from the input motion profile sequence 310 using feature engineering 315, as described elsewhere herein. In other words, the same features will be derived from motion profile sequence 310 during operation as were derived during training.

In an online mode, during operation, sensor data 320 may be also be received as input. It should be understood that the sensor data 320 received during operation will not have the same values as the sensor data 320 used during training, but will have values for the same sensor outputs as the sensor data 320 used during training. In particular, the sensor data 320 received during operation may comprise real-time values of the sensor outputs. It should be understood that the term “real time” or “real-time,” as used herein, encompasses occurrences of events that are simultaneous, as well as occurrences of events that are separated in time by ordinary delays in processing, communications, and/or the like. Feature data 342 may be derived from the input sensor data 320 using the feature building of process 330, as described elsewhere herein. In other words, the same features will be derived from sensor data 320 during operation as were derived during training.

It should be understood that the feature data 342 derived during operation will not have the same values as the feature data 342 used during training, but will have feature values for the same set of features as the feature data 342 used during training. In the offline mode, those features will be entirely derived from motion profile sequence 310 (e.g., via feature engineering 315), whereas in the online mode, those features may be derived from both motion profile sequence 310 and sensor data 320 (e.g., via feature engineering 315 and the feature building of process 330).

Trained predictive model 360 is applied to feature data 342 to predict an output 610, comprising a target value for each of one or more targets in each of one or more future time windows. In other words, feature data 342 is input into trained predictive model 360 to produce output 610. As discussed above, output 610 may consist of a target value for a single target in a single future time window, but more preferably comprises a target value for each of a plurality of targets in a single future time window, a target value for a single target in each of a plurality of future time windows, or a target value for each of a plurality of targets in each of a plurality of future time windows.

As a concrete example, the predicted target for each of a plurality of future time windows may comprise anomaly data 415, such as anomaly score 415A, representing the likelihood of an anomaly. In this case, the predicted target value in each of the plurality of future time windows represents the likelihood that an anomaly (e.g., failure) will occur within that future time window. For instance, for a two-hour future time window that represents a window starting from the current time and ending two hours in the future from the current time, the anomaly score 415A for that two-hour future time window would indicate the likelihood that physical asset 140 will experience an anomaly, such as a failure, within that two-hour future time window.

Notably, in an extreme case, the length of a future time window may be zero. In this case, the predicted target value(s) for that zero-length future time window represent an estimate of the current target value. In other words, for the zero-length future time window, the predicted target value(s) represent a prediction of the current real-time target value(s) for the target(s) associated with the physical asset 140 that is currently executing the input motion profile sequence 310.

In an embodiment in which output 610 of trained predictive model 360 comprises a plurality of target values (e.g., for a plurality of targets and/or a plurality of future time windows), the target values may be aggregated in an aggregation process 620 into an aggregated target value 630. For example, the target values for a plurality of targets in a single future time window may be aggregated into a single aggregated target value 630 for that future time window. As another example, the target values for a single target in a plurality of future time windows may be aggregated into a single aggregated target value 630 across all of the future time windows. As yet another example, the target values for a plurality of targets in a plurality of future time windows may be aggregated into a single aggregated target value 630 across all targets and all future time windows, an aggregated target value 630 across all targets for each of the plurality of future time windows, or an aggregated target value 630 for each of the plurality of targets across all future time windows.

Aggregation process 620 may comprise calculating an average, weighted average, minimum, maximum, and/or the like of the target values in output 610. In an embodiment, a weighted average is used, with different weights assigned to different targets and/or different future time windows. The weights may be defined based on business requirements and/or other criteria. As an alternative, the target value for a specific target in a specific future time window may be designated as a primary target value, and the remainder of the target values may be designated as constraints. This may be appropriate in an application in which the operator of physical asset 140 cares more about a specific target with a specific lead time as a key performance indicator.

### 2.6. Optimization

As discussed above, trained predictive model 360 can be used to evaluate a motion profile sequence. In particular, features may be derived from a motion profile sequence 310 (e.g., in both the offline and online modes) and/or real-time sensor data 320 (e.g., in the online mode), and trained predictive model 360 may be applied to those features to predict at least one, and preferably a plurality of, target values. Notably, the prediction capability of trained predictive model 360 will generally be better in the online mode than in the offline mode, since there is more data from which to make inferences. In either case, the target value(s) represent the performance of motion profile sequence 310. Thus, trained predictive model 360 may be used as an evaluator when building an optimization model for motion profile sequences.

Optimization refers to the problem of determining what sequence of motion profiles provides the optimal target value for each of the target(s) being evaluated. In an offline mode, optimization may find a motion profile sequence that achieves optimal target values based on features derived from each motion profile sequence. In an online mode, optimization may select a next motion profile that achieves optimal target values within some future time window based on the preceding sequence of motion profiles and associated real-time sensor data collected for those motion profiles. Notably, the disclosed optimization solutions can discover an optimal motion profile sequence, even if that optimal motion profile sequence did not exist in the training data.

In the following discussion, for ease of understanding, it will be assumed that, for a given target, a higher target value is more optimal than a lower target value. However, it should be understood that, alternatively, a lower target value may be more optimal than a higher target value, depending on how the target is defined. For example, in the event that higher values of anomaly score 415A represent a higher likelihood of an anomaly, lower values of anomaly score 415A would be more optimal than higher values of anomaly score 415A.

### 2.6.1 Offline Optimization

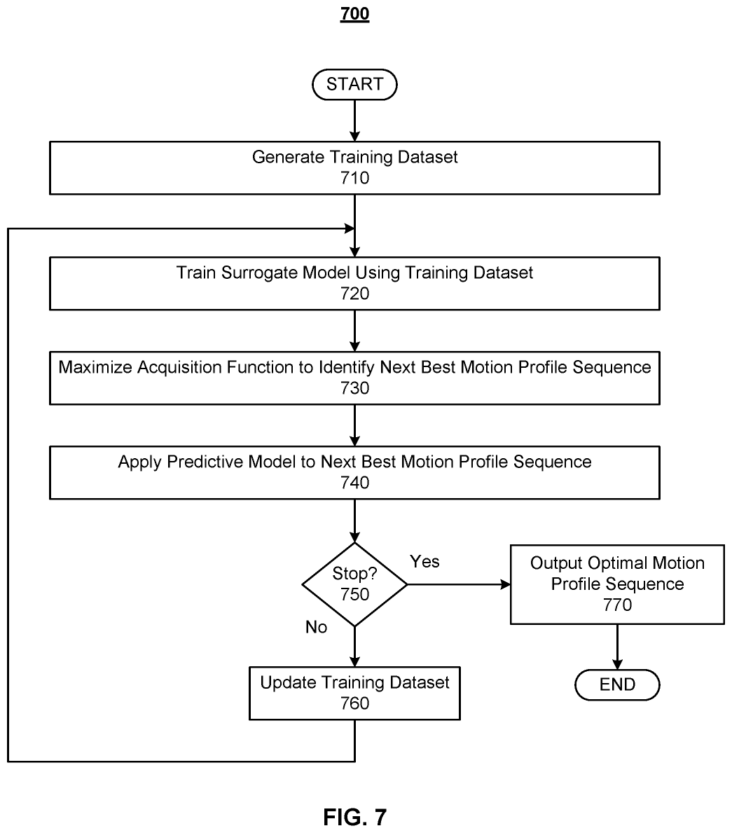

FIG. 7 illustrates a process 700 for offline optimization, according to an embodiment. Process 700 may be used to select a motion profile sequence that achieves optimal target values when real-time sensor data is not available.

In subprocess 710, a training dataset is generated. The training dataset may be prepared in the same manner as described elsewhere herein with respect to training data 340 in the offline mode. For example, the training dataset that is generated in subprocess 710 may be training data 340 or derived from training data 340. In particular, the training dataset may comprise, as each of a plurality of data points, a feature set derived from one of one or a plurality of motion profile sequences 310, labeled with one or more target values. In an embodiment, each feature set is labeled with only a single aggregated target value 630, which may be an aggregate of a plurality of target values (e.g., aggregated by aggregation process 620).

In an embodiment, for motion profile sequences that are the same, the target value(s) for those motion profile sequences may be aggregated when generating the dataset. In other words, since the feature sets will be the same (because they are derived solely from the motion profile sequences in the offline mode), the target value(s) across all of the identical motion profile sequences can be aggregated to also be the same. In this case, the training dataset may consist of only a single data point for each unique motion profile sequence. That single data point will comprise the feature set derived from that motion profile sequence, labeled with the aggregated target value(s) for that feature set. The aggregation may comprise an average, weighted average, minimum, maximum, and/or the like.

In subprocess 720, the training dataset is used to train the surrogate model within a Bayesian optimization algorithm. The surrogate model represents an approximated function f(x) that fits the “observed” data points in the training dataset and quantifies the uncertainty of “unobserved” areas. It should be understood that, in this case, x represents the feature values and f(x) represents the target value(s). As an example, the surrogate model may be a Gaussian Regression model. However, it should be understood that any model that can approximate a function f(x) may be used as the surrogate model, including, for example, a Tree Parzen Estimator or a simpler model, such as a linear model, tree-based model, or the like.

In subprocess 730, the acquisition function within the Bayesian optimization algorithm is maximized to identify the next best motion profile sequence. In particular, the acquisition function analyzes the surrogate model to determine what areas in the approximated function f(x) are worth exploiting and exploring. The acquisition function will produce higher values for areas in which f(x) is optimal and for unobserved areas, and will produce lower values for areas in which f(x) is sub-optimal and for observed areas. As an example, the acquisition function may be a Probability of Improvement function, an Upper Confidence Bound function, an Expected Improvement function, a Bayesian Expected Loss function, a Thompson sampling function, a hybrid of one or more of these functions, or the like.

An x that maximizes the acquisition function represents the next best guess. In this case, since x represents the features of a motion profile sequence, the x that maximizes the acquisition function represents the next best guess for a motion profile sequence (i.e., a motion profile sequence having the features in x). Thus, the next best motion profile sequence may be identified based on the x that maximizes the acquisition function, for example, by selecting a motion profile sequence that has features matching x or more closely matching x than any other available motion profile sequence.

In subprocess 740, the offline version of trained predictive model 360 is applied to the next best motion profile sequence that was identified in subprocess 730. In particular, feature data 342 may be derived from the next best motion profile sequence, as discussed elsewhere herein with respect to the offline mode, and provided as input to trained predictive model 360, to produce predicted target values 610 and/or or an aggregated target value 630.

In subprocess 750, it is determined whether or not a stopping condition is satisfied. The stopping condition may comprise or consist of the number of iterations of subprocesses 720-740, referred to as “epochs,” reaching a predefined threshold. Alternatively or additionally, the stopping condition may comprise other criteria, such as the expiration of an execution timer, the predicted target value(s) in subprocess 740 satisfying (e.g., exceeding) a predefined threshold, the variance or entropy reduction rate satisfying a predefined threshold, and/or the like. If the stopping condition is not satisfied (i.e., “No” in subprocess 750), process 700 proceeds to subprocess 760. Otherwise, if the stopping condition is satisfied (i.e., “Yes” in subprocess 750), process 700 proceeds to subprocess 770.

In subprocess 760, the training dataset is updated with a data point representing the next best motion profile sequence. In particular, the feature data 342 that was derived in subprocess 740 are labeled with the target value(s) that were predicted in subprocess 740 to produce the new data point. This new data point, representing a new observation, is added to the training dataset. The updated training dataset is then used to retrain the surrogate model in a new epoch.

In subprocess 770, the optimal motion profile sequence is output. Depending on how the stopping condition is defined, the optimal motion profile sequence may be the motion profile sequence that was identified in the last epoch. In this case, subprocess 770 may output the most recently identified motion profile sequence (i.e., the motion profile sequence identified in the final iteration of subprocess 730). Alternatively, subprocess 770 may output the motion profile sequence for which trained predictive model 360 predicted the optimal target value(s) (e.g., highest aggregated target value 630) in subprocess 740. In this case, an identifier of each motion profile sequence and its predicted target value(s) for each iteration of subprocess 740 may be stored in each epoch, and subprocess 770 may select the stored motion profile sequence with the optimal (e.g., highest) stored target value(s).

As described above, process 700 utilizes Bayesian optimization. However, other optimization approaches may be used instead of Bayesian optimization. For example, alternative optimization approaches include, without limitation, grid search (e.g., coarse-to-grain), random search, and the like.

### 2.6.2 Online Optimization

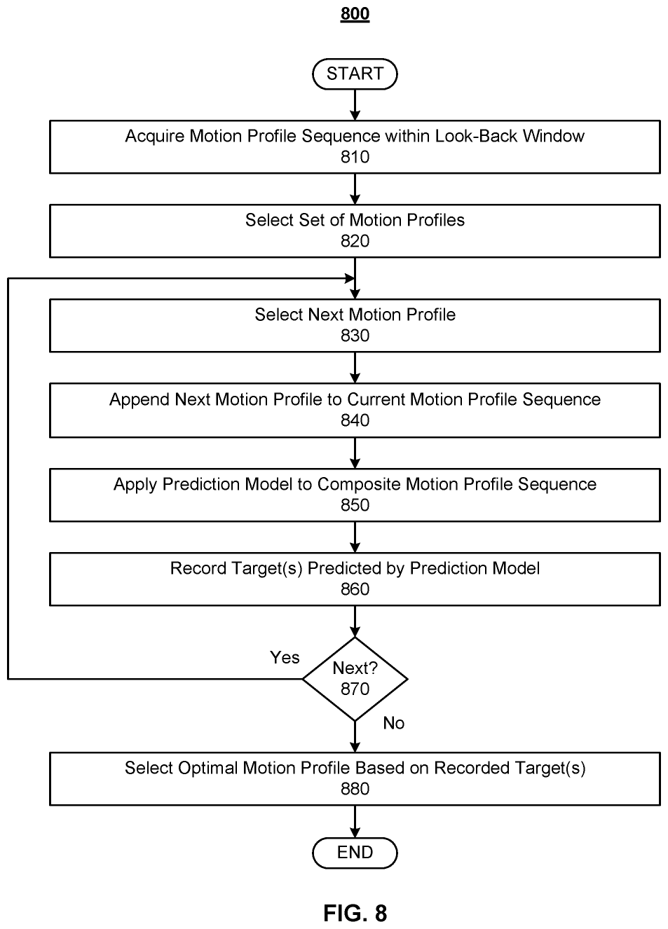

FIG. 8 illustrates a process 800 for online optimization, according to an embodiment. Process 800 may be used to build a motion profile sequence that achieves optimal target value(s) at a future time point, in real time, when real-time sensor data is available. The future time point may be the end of a future time window, beginning with the current time, such that the future time window represents a lead time.

In subprocess 810, the motion profile sequence within a look-back window is acquired. The look-back window may be defined as the length of the look-back window used to derive features (e.g., by feature engineering 315 and feature/target building process 330) minus one time unit. A time unit may consist of a single motion profile, a portion of a motion profile, two or more motion profiles, or any other time window, representing a time window of movements to be added to the current motion profile sequence. The look-back window may be a multiple of the time unit. For ease of description, it will be assumed that the time unit consists of a single motion profile and the look-back window is a multiple of the time unit, such that the look-back window defines a motion profile sequence with an integer number of motion profiles. The motion profile sequence S within the look-back window represents the sequence of motion profiles that have been executed by a physical asset 140 up to the current time.

In subprocess 820, a set of motion profiles are selected as candidates to be added to the motion profile sequence S as the next motion profile to be executed by physical asset 140. A predefined number N of motion profiles may be sampled as candidates from a set of all potential motion profiles. In an embodiment, the predefined number N of motion profiles may be selected by firstly selecting a set X of motion profile sequences that comprise motion profile sequence S as a prefix. Secondly, the predefined number N of motion profiles may be sampled as candidates from this set X of motion profile sequences. The motion profiles that are sampled as candidates will be the motion profiles occurring immediately after the prefix of motion profile sequence S in each of the motion profile sequences in set X. For example, if motion profile sequence S consists of motion profile MP₁ followed by motion profile MP₂ followed by motion profile MP₃, a motion profile sequence that consists of MP₁ followed by motion profile MP₂ followed by motion profile MP₃ followed by motion profile MP₄ followed by motion profile MP₅ may be selected for set X. In this example, motion profile MP₄ represents a candidate for the next motion profile.

In an embodiment, a set X of motion profile sequences that comprise motion profile sequence S as a prefix is determined using process 700. For example, process 700 may be used to identify a set of one or a plurality of optimal motion profile sequences (i.e., associated with relatively high target value(s)) within the domain of motion profile sequences that have motion profile sequence S as a prefix. In an alternative embodiment, an aggregated target value 630 may be determined for all motion profile sequences with motion profile sequence S as a prefix. In this case, the aggregated target values 630 may be normalized and the set X of motion profile sequences may be selected based on probabilities, or the motion profile sequences may be ranked according to their aggregated target values 630 and a top number of the motion profile sequences may be selected for set X.

In an embodiment, the selection of motion profiles in subprocess 820 may implement both exploitation and exploration. For example, the set X of motion profile sequences may be split into a subset Xₑₓₚₗₒᵢₜ and a subset Xₑₓₚₗₒᵣₑ. The subset Xₑₓₚₗₒᵢₜ consists of highly desirable motion profile sequences. Highly desirable motion profile sequences are those for which the target values (e.g., aggregated target value 630), predicted by trained predictive model 360, are relatively high. In an alternative embodiment, subprocess 820 may generate the subset Xₑₓₚₗₒᵢₜ by appending every possible motion profile to motion profile sequence S. The subset Xₑₓₚₗₒᵣₑ, on the other hand, consists of the remaining motion profile sequences in set X (i.e., motion profile sequences for which the target values, predicted by trained predictive model 360, are relatively low). Set X may be split into subsets Xₑₓₚₗₒᵢₜ and Xₑₓₚₗₒᵣₑ based on a predefined number of motion profile sequences to be included in either subset Xₑₓₚₗₒᵢₜ or subset Xₑₓₚₗₒᵣₑ, a threshold value for the target value(s), and/or the like. Subprocess 820 may then select (e.g., randomly sample) a predefined number Nₑₓₚₗₒᵢₜ of motion profile sequences from subset Xₑₓₚₗₒᵢₜ, and select (e.g., randomly sample) a number Nₑₓₚₗₒᵣₑ=N−Nₑₓₚₗₒᵢₜ of motion profile sequences from subset Xₑₓₚₗₒᵣₑ. In an alternative embodiment, Thompson sampling may be used to select the predefined number N of motion profile sequences from set X.

Once a set of N motion profiles has been selected in subprocess 820, the loop formed by subprocesses 830-870 is performed iteratively for each of the N motion profiles. In other words, this loop is performed over N iterations. In subprocess 830, the next motion profile is selected from the set of N motion profiles selected in subprocess 820.

In subprocess 840, the next motion profile, selected in subprocess 830, is appended to the current motion profile sequence. Feature values are derived for the composite motion profile sequence, consisting of the current motion profile sequence with the appended next motion profile. The feature values for the current motion profile sequence may be derived from the current motion profile sequence and the real-time sensor data, as discussed elsewhere herein. The feature values for the next motion profile may be derived from the motion profile and historical sensor data, and appended to the feature values derived for the current motion profile sequence to produce feature data 342. The feature values for the next motion profile may be derived by aggregating historical sensor data for the next motion profile into aggregated feature values for each feature. The aggregation may comprise an average, weighted average, minimum, maximum, and/or the like.

In subprocess 850, the online version of trained predictive model 360 is applied to the feature values derived from the composite motion profile sequence in subprocess 840. In particular, feature data 342 may be input to trained predictive model 360 to produce predicted target values 610 and/or an aggregated target value 630 for one or a plurality of future time windows.

In subprocess 860, the target value(s) are stored in association with the corresponding future time window. For example, the target value that is stored in each iteration of subprocess 860 may be the aggregated target value 630 produced by aggregation process 620 for each future time window for each application of predictive model 360. In this case, the target values over the N iterations may be stored in a two-dimensional matrix with a first dimension representing all iterations and a second dimension representing all future time windows. It should be understood that each value in the matrix represents an aggregated target value 630 for a unique combination of iteration and future time window.

In subprocess 870, it is determined whether or not there is another motion profile to consider. In other words, it is determined whether or not all of the N motion profiles, selected in subprocess 820, have been considered. If another motion profile remains to be considered (i.e., “Yes” in subprocess 870), process 800 returns to subprocess 830. Otherwise, if no motion profiles remain to be considered (i.e., “No” in subprocess 870), process 800 proceeds to subprocess 880.

In subprocess 880, the optimal motion profile to be executed is selected based on the target values recorded over all iterations of subprocess 860. In particular, the next motion profile with the most optimal (e.g., highest) recorded target value for a given future time window or aggregated across all future time windows may be selected. The optimal motion profile, selected in subprocess 880, may be deployed to physical asset 140, such that physical asset 140 moves according to this motion profile while performing its task. In other words, physical asset 140 is controlled to execute the optimal motion profile selected in subprocess 880.

### 3. Example Embodiments

Embodiments of training and operating a predictive model 360 are disclosed. Predictive model 360 may be trained and operated to predict one or a plurality of target values for each of one or a plurality of future time windows from feature values for a motion profile sequence. Predictive model 360 may be provided in one or both of an offline mode, which predicts target values based only on the motion profile sequence, and an online mode, which predicts target values based on both the motion profile sequence and sensor data.

In an embodiment, only the motion profile sequence and sensor data are used to build predictive model 360. In other words, target values do not need to be explicitly collected. Rather, the target values for one or a plurality of targets may be automatically derived from the sensor data using one or more techniques (e.g., implemented by feature/target building process 330). For example, these techniques may include, without limitation, using an unsupervised ensemble anomaly detection model (e.g., anomaly detection model 540) to detect anomalies (e.g., failures) from sensor data, calculating position accuracy from control and observed position data, transforming vibration data from the frequency domain to the spatial domain, transforming acoustic data from the frequency domain to the spatial domain, deriving the production or yield rate from recorded data, setting an upper time limit for optimization (e.g., in the stopping condition of subprocess 750), and/or the like.

In an embodiment, predictive model 360 comprises a deep-learning neural network, and may predict target values for a plurality of targets concurrently. This enables correlations among targets to be captured, thereby improving model performance and reducing training time. The targets may be predicted for a plurality of future time windows, concurrently, using a single predictive model 360. This provides a distribution of target values along a future timeline, which can inform decision-making in automated and manual prediction and optimization. The target values may be aggregated (e.g., by aggregation process 620) into an aggregated target value 630 for each future time window or across all future time windows.

In an embodiment, predictive model 360 may be used to evaluate manually designed motion profile sequences. Additionally or alternatively, predictive model 360 may be used for offline or online optimization. In offline optimization, predictive model 360 is used to find the motion profile sequence that achieves the optimal target value(s), based on historical data and using an optimization technique, such as Bayesian optimization, grid search, random search, or the like. In online optimization, predictive model 360 is used to find the next motion profile that achieves the optimal target value(s), based on real-time data and using an approach with both exploitation and exploration.

The result of optimization may be an optimal motion profile sequence (e.g., in offline mode) or an optimal next motion profile (e.g., in online mode). In either case, the motion profile sequence or next motion profile may be used to control a physical asset 140. For example, the motion profile sequence or next motion profile may be deployed by platform 110 or a controller of physical asset 140 to physical asset 140. Physical asset 140 may perform the deployed motion profile sequence or next motion profile to perform a task or a portion of a task.

As one non-limiting concrete example, a physical asset 140 may be subject to jerk. Jerk refers to a rate of change in acceleration. For triangular and trapezoidal motion profiles, the initial acceleration and final deceleration occur instantly, which means that jerk is theoretically infinite. Jerk can be especially problematic for systems that require smooth, accurate movements, because vibrations caused by jerk can reduce position accuracy and extend settling time. The disclosed optimization can reduce jerk by selecting motion profiles that smooth the beginning and endings of the acceleration and deceleration phases into an “S” shape. This can limit the rate of change of acceleration and deceleration (i.e., the jerk) and produce smoother motion and more accurate positioning.

As another non-limiting concrete example, a physical asset 140 may be subject to overheating. There may be a tradeoff in which physical asset 140 may operate according to a first motion profile sequence with a higher rate of throughput but a higher likelihood of overheating, or a second motion profile sequence with a lower rate of throughput but a lower likelihood of overheating. The disclosed optimization can identify the likelihood of an overheating failure in a future time window (e.g., as indicated by anomaly score 415A and root cause 415B as a target in the future time window), and adjust the motion profile sequence between the first and second motion profile sequences accordingly, to maximize throughput while avoiding overheating. More generally, the disclosed optimization may be used to reduce downtime (e.g., failures and other anomalies) and increase efficiency of physical asset(s) 140.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to train a predictive model to predict target values for a motion profile sequence, the method comprising:
receiving a motion profile sequence comprising a sequence of motion profiles, wherein each motion profile defines one or more movements for a physical asset to perform a task;
receiving sensor data associated with the motion profile sequence;
generating training data from the motion profile sequence and the sensor data, wherein the training data comprise a plurality of feature sets, each of the plurality of feature sets comprising a feature value for each of one or more features derived from at least the motion profile sequence, and wherein each of the plurality of feature sets is labeled with a target value for each of a plurality of targets derived from at least the sensor data; and
training a predictive model to predict a target value for each of the plurality of targets for at least one future time window, based on the training data.

2. The method of claim 1, further comprising determining an optimal motion profile sequence using the trained predictive model.

3. The method of claim 2, wherein determining an optimal motion profile sequence comprises:
generating a training dataset comprising a plurality of feature vectors, wherein each feature vector comprises a motion profile sequence, labeled with one or more target values for that motion profile sequence;
until a stopping condition is satisfied, iteratively,
building a surrogate model using the training dataset,
maximizing an acquisition function of the surrogate model to identify a next motion profile sequence,
applying the trained predictive model to one or more feature values derived for the next optimal motion profile sequence to predict at least one target value for the next motion profile sequence, and
adding a feature vector to the training dataset, wherein the added feature vector comprises the next motion profile sequence, labeled with the at least one target value predicted for the next motion profile sequence; and,
after the stopping condition is satisfied, select the optimal motion profile sequence based on the predicted at least one target values.

4. The method of claim 3, wherein the surrogate model is a Gaussian regression model.

5. The method of claim 2, wherein each of the plurality of feature sets is derived from both the motion profile sequence and the sensor data, and wherein determining an optimal motion profile sequence comprises:
acquiring an existing motion profile sequence within a lookback window;
selecting a plurality of potential motion profile sequences that include the existing motion profile sequence as a prefix;
for each of the plurality of potential motion profile sequences, applying the trained predictive model to one or more feature values derived from the potential motion profile sequence and real-time sensor data to predict at least one target value for that potential motion profile sequence; and
selecting the optimal motion profile sequence from the potential motion profile sequences based on the predicted at least one target values for the potential motion profile sequences.

6. The method of claim 5, wherein selecting a plurality of potential motion profile sequences comprises, from a set of available motion profile sequences that include the existing motion profile sequence as a prefix:
splitting the set of available motion profile sequences into a first subset and a second subset, wherein each of the available motion profile sequences is associated with at least one previously determined target value, and wherein the first subset consists of motion profile sequences that are associated with higher values of the at least one previously determined target value than the second subset;
randomly sampling a first number of potential motion profile sequences from the first subset; and
randomly sampling a second number of potential motion profile sequences from the second subset.

7. The method of claim 5, further comprising controlling the physical asset to perform the task according to the optimal motion profile sequence.

8. The method of claim 1, wherein each of the one or more movements is defined by one or more of a position, a velocity, or an acceleration.

9. The method of claim 1, wherein the sensor data comprise one or both of historical data collected by sensors monitoring the physical asset or synthetic data generated using a simulation of the physical asset.

10. The method of claim 1, wherein generating training data comprises:
deriving an anomaly feature set based on the sensor data; and
applying an anomaly scoring model to the anomaly feature set to produce an anomaly score,
wherein the one or more features comprise the anomaly score.

11. The method of claim 10, further comprising using the at least one hardware processor to train the anomaly scoring model using unsupervised learning.

12. The method of claim 10, wherein generating training data further comprises applying an explainable artificial intelligence model to a surrogate anomaly scoring model, which has been trained using supervised learning, to determine a root cause for the anomaly score, wherein the one or more features further comprise the root cause.

13. The method of claim 12, wherein the anomaly feature set comprises a feature value for each of a plurality of anomaly features, wherein the method further comprises training the surrogate anomaly scoring model using a training dataset comprising a second plurality of feature sets, and wherein each of the second plurality of feature sets comprises a feature value for each of the plurality of anomaly features and is labeled with the anomaly score produced by the anomaly scoring model for that feature set.

14. The method of claim 10, wherein generating training data further comprises applying one or more feature selection techniques to a surrogate anomaly scoring model, which has been trained using supervised learning, to determine a selected feature set, wherein the one or more features further comprise the selected feature set.

15. The method of claim 10, wherein the anomaly feature set comprises a feature value for each of a plurality of anomaly features, and wherein the method further comprises identifying the plurality of anomaly features by:
generating a plurality of features from the sensor data;
applying an autoencoder to the plurality of features to derive encoded features and decoded features; and
calculating a difference between the plurality of features and the decoded features,
wherein the plurality of anomaly features comprises one or more of the calculated difference, at least a subset of the plurality of features, or at least a subset of the encoded features.

16. The method of claim 1, wherein the one or more features comprise one or more of a position accuracy, vibration data, or acoustic data.

17. The method of claim 1, wherein the plurality of targets comprise one or more of an anomaly score, a position accuracy, vibration data, or acoustic data.

18. The method of claim 1, wherein the method further comprises, during an operation stage:
collecting feature values for the one or more features within a look-back window of sensor data generated for the physical asset;
applying the predictive model to the collected feature values to predict the target value for each of the plurality of targets for the at least one future time window; and
aggregating the predicted target values for the plurality of targets for the at least one future time window into an aggregated target value.

19. The method of claim 1, wherein the at least one future time window is a plurality of future time windows, each of the plurality of future time windows comprising a different time period.

20. The method of claim 1, wherein the one or more features are derived from only the motion profile sequence.

21. A system comprising:
at least one hardware processor; and
software configured to, when executed by the at least one hardware processor,
receive a motion profile sequence comprising a sequence of motion profiles, wherein each motion profile defines one or more movements for a physical asset to perform a task,
receive sensor data associated with the motion profile sequence,
generate training data from the motion profile sequence and the sensor data, wherein the training data comprise a plurality of feature sets, each of the plurality of feature sets comprising a feature value for each of one or more features derived from at least the motion profile sequence, and each of the plurality of feature sets labeled with a target value for each of a plurality of targets derived from at least the sensor data, and
train a predictive model to predict a target value for each of the plurality of targets for at least one future time window, based on the training data.

22. A non-transitory computer-readable medium having instructions stored thereon, wherein the instructions, when executed by a processor, cause the processor to:
receive a motion profile sequence comprising a sequence of motion profiles, wherein each motion profile defines one or more movements for a physical asset to perform a task;
receive sensor data associated with the motion profile sequence;
generate training data from the motion profile sequence and the sensor data, wherein the training data comprise a plurality of feature sets, each of the plurality of feature sets comprising a feature value for each of one or more features derived from at least the motion profile sequence, and each of the plurality of feature sets labeled with a target value for each of a plurality of targets derived from at least the sensor data; and
train a predictive model to predict a target value for each of the plurality of targets for at least one future time window, based on the training data.
